(19) United States
(12) Patent Application Publication
(10) Pub. No.: US 2009/0143132 A1
(43) Pub. Date: Jun. 4, 2009

(54) GAMING MACHINE AWARDING PRIZE BASED ON NUMBER OF SPECIAL SYMBOL AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/054,065

(22) Filed: Mar. 24, 2008

Related U.S. Application Data
(60) Provisional application No. 60/996,756, filed on Dec. 4, 2007.

(51) Int. Cl. A63F 13/00

(52) U.S. Cl. 463/20

(57) ABSTRACT

Disclosed is a gaming machine 1 that is operable under control of a controller 100. The gaming machine includes display windows 151 to 155 of a matrix shape; and a display 101 that is controlled by the controller to arrange a plurality of symbols in the display windows 151 to 155. The controller 100 is programmed to set a predetermined symbol of the symbols 180 as a special symbol 189; to rearrange the symbols 180 based on a predetermined timing; when the symbols 180 rearranged include a special symbol 189, to change the symbols 181 to 183 into the special symbols 189; and to award a prize relative to the number of the special symbols 189.

### CROSS REFERENCE TO RELATED APPLICATION

This application claims the benefit of U.S. Provisional Application No. 60/996,756, filed on Dec. 4, 2007.

### BACKGROUND OF THE INVENTION

1. Field of the Invention

The invention relates to a gaming machine, and a playing method thereof.

2. Description of Related Art

In a conventional gaming machine, when a player inserts a game medium such as coin or bill into an insertion slot of the gaming machine and presses a start button, symbols are scrolled in a display mounted on a front of a cabinet and the symbols are then stopped automatically.

In such gaming machine, as disclosed in U.S. Pat. No. 6,604,999 B2 or U.S. Patent No. 2002065124A1 or U.S. Pat. No. 20040053676A1, for example, when the symbols stopped on a winning line constitute a predetermined combination, the predetermined number of game media are paid out as a win. In addition, when a certain symbol referred to as scatter symbol is displayed on the display, the predetermined number of game media are paid out in accordance with the number of scatter symbols displayed, irrespective of the winning line. Further, there is a gaming machine adopting a wild scatter symbol that replaces the other defined symbols.

In the conventional gaming machines, a bonus game may be executed when a predetermined condition is fulfilled, separately from a base game in which the predetermined number of game media is paid out in accordance with a combination of symbols or the number of scatter symbols. In the bonus game, a player should understand a rule so as to determine whether a prize is awarded or not, which is troublesome for the player. In addition, in the gaming machine adopting the wild scatter symbol, a combination of a plurality of types of symbols make a winning combination, so that a player may not know what winning combination is made.

An object of the invention is to provide a gaming machine having an entertainment characteristic that a player can easily know, which is not provided to the prior art, and a playing method thereof.

In addition, another object of the invention is to provide a gaming machine in which a situation of whether a prize is awarded is visually recognized, and a playing method thereof.

### SUMMARY OF THE INVENTION

According to the invention, there is provided a gaming machine that is operable under control of a controller, the gaming machine including: an arrangement area of a matrix shape; and a display that is controlled by the controller to arrange a plurality of scatter symbols in the arrangement area. The controller is programmed to operate as described in following steps of (a1) to (a4). Specifically, the controller operates (a1) to set a predetermined scatter symbol of the scatter symbols as a special symbol; (a2) to rearrange the scatter symbols based on a predetermined timing; (a3) when the scatter symbols rearranged include the special symbol, to change the predetermined scatter symbol into the special symbol; and (a4) to award a prize relative to the number of the special symbols.

According to the above structure, when the scatter symbols rearranged include the special symbol, the predetermined scatter symbol is changed into the special symbol and a prize relative to the number of the special symbols after the change can be awarded. Thereby, a player can know an obtainable prize by seeing the number of the special symbols rearranged on a display, so that a game characteristic, which is simple and easy for the player, can be provided.

According to the invention, there is provided a gaming machine that is operable under control of a controller, the gaming machine including: an arrangement area of a matrix shape; and a display that is controlled by the controller to arrange a plurality of scatter symbols in the arrangement area. The scatter symbols include a scatter symbol that is capable of being changed into a special symbol and a scatter symbol that is not capable of being changed into a special symbol. The controller is programmed to operate as described in following steps of (b1) to (b4). Specifically, the controller operates (b1) to set a predetermined scatter symbol of the scatter symbols as a special symbol; (b2) to rearrange the scatter symbols based on a predetermined timing; (b3) when the scatter symbols rearranged include the special symbol, to change the scatter symbol, which is capable of being changed into a special symbol, into the special symbol; and (b4) to award a prize relative to the number of the special symbols rearranged.

According to the above structure, when the scatter symbols rearranged include the special symbol, the scatter symbol, which is capable of being changed into a special symbol, is changed into the special symbol and a prize relative to the number of the special symbols after the change can be awarded. Thereby, a player can know an obtainable prize by seeing the number of the scatter symbols that can be changed into the special symbols rearranged on a display, so that a game characteristic, which is simple and easy for the player, can be provided.

According to the invention, there is provided a gaming machine that is operable under control of a controller, the gaming machine including: an arrangement area of a matrix shape; a display that is controlled by the controller to arrange a plurality of scatter symbols in the arrangement area; and a bonus game that is operable when the scatter symbols rearranged include a predetermined relation. The controller is programmed to operate as described in following steps of (c1) to (c6). Specifically, the controller operates (c1) to rearrange the scatter symbols, based on a predetermined timing; (c2) to award a bonus game when a relation of the scatter symbols rearranged includes a predetermined relation; (c3) to set a predetermined scatter symbol of the scatter symbols as a special symbol in the bonus game; (c4) to rearrange the scatter symbols based on a predetermined timing; (c5) when the scatter symbols rearranged include the special symbol, to change the predetermined scatter symbol into the special symbol; and (c6) to award a prize relative to the number of the special symbols.

According to the above structure, when a bonus game is awarded, a predetermined scatter symbol is changed into a special symbol when the scatter symbols rearranged include a special symbol, and a prize relative to the number of the special symbols after the change can be awarded. Thereby, a player can know an obtainable prize by seeing the number of the special symbols rearranged on a display, so that a game characteristic, which is simple and easy for the player, can be provided.

According to the invention, there is provided a gaming machine that is operable under control of a controller, the gaming machine including: an arrangement area of a matrix shape; a display that is controlled by the controller to arrange a plurality of scatter symbols in the arrangement area; and a bonus game that is operable when the scatter symbols arranged include a predetermined relation. The scatter symbols include a scatter symbol that is capable of being changed into a special symbol and a scatter symbol that is not capable of being changed into a special symbol. The controller is programmed to operate as described in following steps of (d1) to (d6). Specifically, the controller operates (d1) to rearrange the scatter symbols, based on a predetermined timing; (d2) to award a bonus game when a relation of the scatter symbols rearranged includes a predetermined relation; (d3) to set a predetermined scatter symbol of the scatter symbols as a special symbol in the bonus game; (d4) to rearrange the scatter symbols based on a predetermined timing; (d5) when the scatter symbols rearranged include the special symbol, to change the predetermined scatter symbol into the special symbol; and (d6) to award a prize relative to the number of the special symbols.

According to the above structure, in case that a bonus game is awarded, when the scatter symbols rearranged include a special symbol, a scatter symbol, which is capable of being changed into a special symbol, is changed into a special symbol and a prize relative to the number of the special symbols after the change can be awarded. Thereby, a player can know an obtainable prize by seeing the number of the scatter symbols that are capable of being changed into the special symbols rearranged on a display, so that a game characteristic, which is simple and easy for the player, can be provided.

According to the invention, there is provided a playing method of a gaming machine using an arrangement area of a matrix shape and a display that is controlled to arranged a plurality of scatter symbols in the arrangement area, the method including the steps of: setting a predetermined scatter symbol of the scatter symbols as a special symbol; rearranging the scatter symbols, based on a predetermined timing; when the scatter symbols rearranged include the special symbol, changing the predetermined scatter symbol into the special symbol; and awarding a prize relative to the number of the special symbols.

According to the above structure, when the scatter symbols rearranged include the special symbol, the predetermined scatter symbol is changed into the special symbol and a prize relative to the number of the special symbols after the change can be awarded. Thereby, a player can know an obtainable prize by seeing the number of the special symbols rearranged on a display, so that a game characteristic, which is simple and easy for the player, can be provided.

### BRIEF DESCRIPTION OF THE DRAWINGS

FIG. 1 illustrates a playing method of a gaming machine;

FIG. 2 is a block diagram of a gaming machine;

FIG. 3 illustrates a display screen in a basic game;

FIG. 4 illustrates a display screen in a bonus game;

FIG. 5 is a perspective view showing an external appearance of a gaming machine;

FIG. 6 shows symbols and code numbers thereof;

FIG. 7 is a block diagram showing an electrical structure of an entire gaming machine;

FIG. 8 is a block diagram showing an electrical structure of a sub-control board of a gaming machine;

FIG. 9 shows a winning combination lottery table for a base game;

FIG. 10 shows a winning combination lottery table for a bonus game;

FIG. 11 shows a payout table for a bonus game;

FIG. 12 is a flow chart of a game executing process that is performed in a gaming machine; and

FIG. 13 is a flow chart of a bonus game process that is performed in a gaming machine.

### DESCRIPTION OF THE PREFERRED EMBODIMENTS

### First Embodiment

Hereinafter, it will be described an embodiment of a gaming machine and a playing method according to the invention.

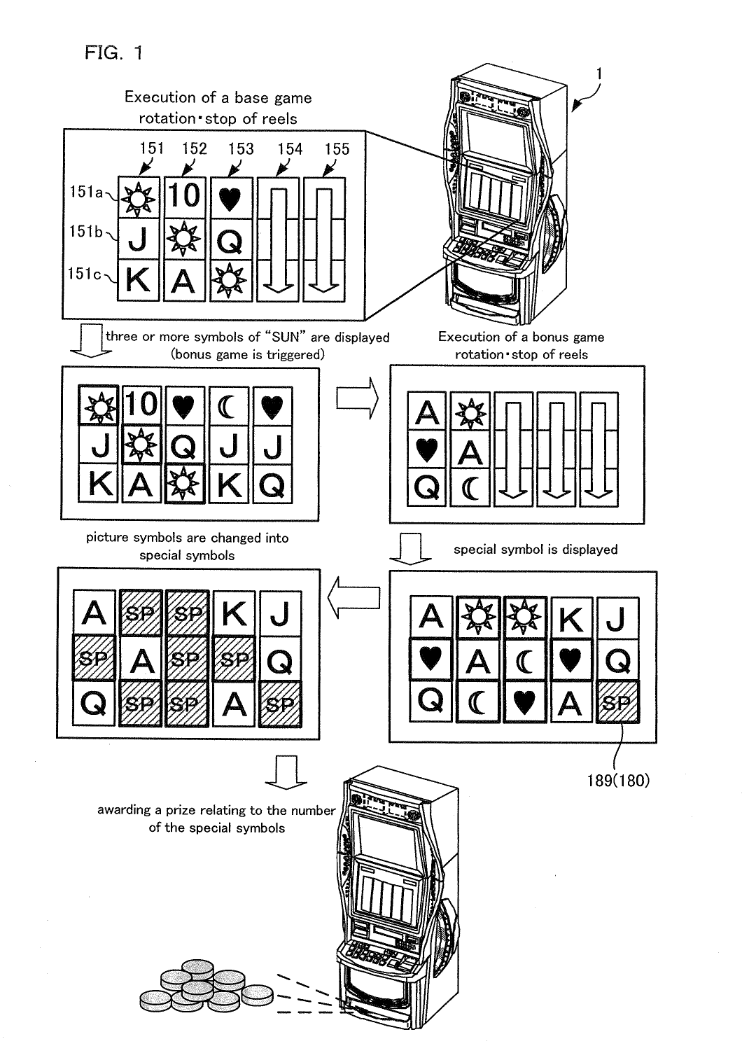

As shown in FIG. 1, a gaming machine executes a playing method including the steps of rearranging scatter symbols 180, based on a predetermined timing; when a relation of the scatter symbols 180 rearranged includes a predetermined relation, awarding a bonus game; setting a predetermined scatter symbol of the scatter symbols 180 as a special symbol 189 in the bonus game; rearranging the scatter symbols 180, based on a predetermined timing; when the scatter symbols 180 rearranged include the special symbol 189, changing the scatter symbols 180 (picture symbols of “SUN” 181, “HEART” 182 and “MOON” 183), which can be changed into a special symbol, into the special symbols 189; and awarding a prize relative to the number of the special symbols 189.

Herein, the “arrangement” means a state in which the symbols 180 are allowed to be visible with naked eyes of an exterior player. In other words, in FIG. 1, the symbols 180 are under state of being displayed in the display windows 151 to 155. In the mean time, the “rearrangement” means arranging the symbols 180 again after dismissing the arrangement of the symbols 180.

(Display 101)

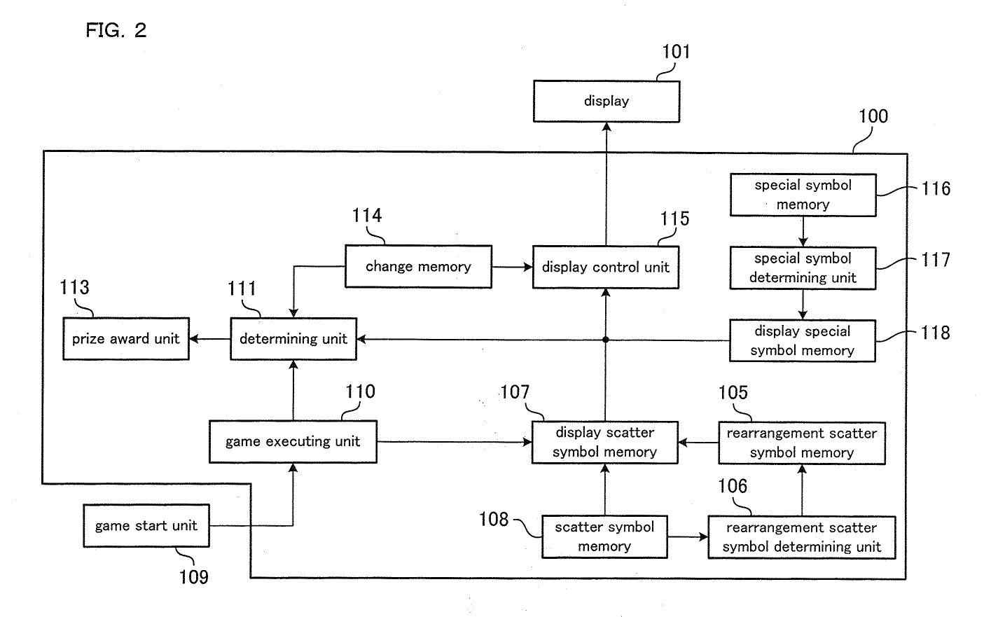

The gaming machine that executes the playing method has, as shown in FIG. 2, a display 101 and a controller 100. The display 101 is configured to arrange symbols 180. The symbols 180 include the symbols 181 to 188 and the special symbol 189.

The display 101 may be a mechanical structure with a reel device for arranging the symbols 180 by rotation of a reel or electrical structure with a video reel on which an image is displayed for arranging the symbols 180. Further, the first display 101 may be a structure of combining a mechanical structure (reel) and an electrical structure (video reel). The electrical structure may include a liquid crystal device, a CRT (cathode-ray tube), a plasma display and the like. In addition, the number of the display windows 151 to 155 may be arbitrary. A detailed structure of the first display area 101 will be described later.

(Controller 100)

The controller 100 is structured to execute a first process of rearranging symbols 180, based on a predetermined timing; a second process of: when a relation of the symbols 180 rearranged includes a predetermined relation, awarding a bonus game; a third process of setting a predetermined symbol of the symbols 180 as a special symbol 189 in the bonus game; a fourth process of rearranging the symbols 180, based on a predetermined timing; a fifth process of: when the symbols 180 rearranged include the special symbol 189, changing the symbols 180 (picture symbols of “SUN” 181, “HEART” 182 and “MOON” 183), which can be changed into a special symbol, into the special symbols 189; and a sixth process of awarding a prize relative to the number of the special symbols 189. In other words, the controller 100 has first to sixth processing units.

The controller 100 includes a scatter symbol memory 108 for storing all symbols 180 and a display scatter symbol memory 107 for storing the symbols 180 in the scatter symbol memory 108 as a display symbol. The display scatter symbol memory 107 can be accessed by a display control unit 115. The display control unit 115 reads out the symbols 180 in the display scatter symbol memory 107 under control of a game executing unit 110 and displays the symbols 180 in the display 101.

In addition, the controller 100 includes a rearrangement scatter symbol determining unit 106 that determines symbols to be rearranged every unit game, based on the symbols 180 stored in the scatter symbol memory 108. The symbols to be rearranged, which are determined by the rearrangement scatter symbol determining unit 106, are stored in a rearrangement scatter symbol memory 105, are outputted to the display scatter symbol memory 107 and are then used for an image process in the display control unit 115, so that they are displayed in the display 101.

In addition, the controller 100 includes a special symbol memory 116 that stores the special symbol 189 and a display special symbol memory 118 that stores the special symbol 189 of the special symbol memory 116 as a special symbol for display. The display special symbol memory 118 can be accessed by the display control unit 115. The display control unit 115 reads out the special symbol 189 of the display special symbol memory 118 and displays the special symbol 189 on the display 101, under control of the game executing unit 110.

In addition, the controller 100 includes a scatter symbol determining unit 117 that determines a position of the special symbol 189 to be rearranged every bonus game based on the special symbol 189 stored in the special symbol memory 116. The special symbol 189 to be rearranged, which is determined by the scatter symbol determining unit 117, is outputted to the display special symbol memory 118 and then used for an image process in the display control unit 115, so that they are displayed on the display 101.

Furthermore, the controller 100 is associated with a game start unit 109. The game start unit 109 has a function of outputting a game start signal by an operation of the player. In addition, the controller 100 includes a game executing unit 110 that executes a unit game of a base game in which the symbols 180 are rearranged and a bonus game, a determining unit 111 that determines a prize in a unit game of a basic game and a prize in a bonus game, a prize award unit 113 that awards the prize determined in the determining unit 111 and a change memory 114 that stores positions of the symbols (picture symbols) 180 that can be changed into a special symbol.

The game executing unit 110 starts, in the display 101, a variable display of the symbols 180 arranged with a game start signal, as trigger, from the game start unit 109 and rearranges the symbols 180 at a timing at which a predetermined time has elapsed after the variable display is started. In other words, the controller 100 executes a first process of rearranging the symbols 180, based on a predetermined timing. The determining unit 111 determines a prize that is determined by a combination of the symbols 180 rearranged in a unit game. In other words, the controller 100 executes a second process of: when a relation of the symbols 180 rearranged includes a predetermined relation, awarding a bonus game.

In addition, when a bonus game is awarded, the display control unit 115 reads out position data of the special symbol 189 from the display special symbol memory 118 whenever the symbols 180 are rearranged, replaces the symbol 180 that agrees with the position data with the special symbol 189 and displays the special symbol in the display 101. In other words, the controller 100 executes a third process of determining a predetermined symbol of the scatter symbols 180 as a special symbol 189 in a bonus game.

In addition, the game executing unit 110 starts, in the display 101, a variable display of the symbols 180 arranged with a bonus game start signal, as trigger, from the game start unit 109 and rearranges the symbols 180 at a timing at which a predetermined time has elapsed after the variable display is started. In other words, the controller 100 executes a fourth process of rearranging the symbols 180, based on a predetermined timing.

In addition, the determining unit 111 determines whether the special symbol 189 is included in the symbols 180 rearranged, in a bonus game. The display control unit 115 reads out data stored in the change memory 114, replaces the symbol 180 that can be changed into a special symbol with the special symbol 189 and displays the special symbol in the display 101. In other words, the controller 100 executes a fifth process of: when the symbols 180 rearranged include the special symbol 189, changing the symbols 180 (picture symbols of “SUN” 181, “HEART” 182 and “MOON” 183), which can be changed into a special symbol, into the special symbols 189.

In addition, the determining unit 111 determines the number of the special symbols 189 that are displayed in the display 101 as a result of the fifth process. The prize award unit 113 awards a prize, based on a determination of the determining unit 111. In other words, the controller 100 executes a sixth process of awarding a prize relative to the number of the special symbols 189.

In the mean time, each block of the controller 100 may be structured with a hardware or software, as required.

(Operation of the Controller 100)

In the followings, an operation of the controller 100 will be described. First, the symbols to be rearranged are determined by the rearrangement scatter symbol determining unit 106 and the determined symbols to be rearranged are stored in the rearrangement scatter symbol memory 105. The symbols to be rearranged, which the rearrangement scatter symbol memory 105 stores, are stored in the display scatter symbol memory 107. The symbols to be rearranged, which are stored in the display scatter symbol memory 107, are enabled to be displayed in the display 101 by the display control unit 115. When a unit game is executed by the game executing unit 110, a variable display of the symbols is started and the symbols to be rearranged, which are stored in the display scatter symbol memory 107, are displayed in the display 101 at a timing at which a predetermined time has elapsed from the start of the variable display, so that the symbols 180 are rearranged. Thereby, the controller 100 executes a first process of rearranging the symbols 180 based on a predetermined timing.

Then, a bonus game based on a predetermined relation of the symbols 180 rearranged is awarded by the determining unit 111. Thereby, the controller 100 executes a second process of awarding a bonus game when a relation of the symbols 180 rearranged includes a predetermined relation.

Furthermore, the display control unit 115 reads out position data of the special symbol 189 from the display special symbol memory 118 whenever the symbols 180 are rearranged, replaces the symbol 180 that agrees with the position data with the special symbol 189 and displays the special symbol in the display 101. Thereby, the controller 100 executes a third process of determining a predetermined symbol of the scatter symbols 180 as a special symbol 189 in a bonus game.

In addition, the game executing unit 110 starts, in the display 101, a variable display of the symbols 180 arranged with a bonus game start signal, as trigger, from the game start unit 109 and rearranges the symbols 180 at a timing at which a predetermined time has elapsed after the variable display is started. Thereby, the controller 100 executes a fourth process of rearranging the symbols 180, based on a predetermined timing.

In addition, the determining unit 111 determines whether the special symbol 189 is included in the symbols 180 rearranged, in a bonus game. The display control unit 115 reads out data stored in the change memory 114, replaces the symbol 180 that can be changed into a special symbol with the special symbol 189 and displays the special symbol in the display 101. Thereby, the controller 100 executes a fifth process of: when the symbols 180 rearranged include the special symbol 189, changing the symbols 180 (picture symbols of “SUN” 181, “HEART” 182 and “MOON” 183), which can be changed into a special symbol, into the special symbols 189.

In addition, the determining unit 111 determines the number of the special symbols 189 that are displayed in the display 101 as a result of the fifth process. The prize award unit 113 awards a prize, based on a determination of the determining unit 111. Thereby, the controller 100 executes a sixth process of awarding a prize relative to the number of the special symbols 189.

As clearly seen from the above operations, the gaming machine 1 embodies a playing method including the steps of rearranging scatter symbols 180, based on a predetermined timing; when a relation of the scatter symbols 180 rearranged includes a predetermined relation, awarding a bonus game; setting a predetermined scatter symbol of the scatter symbols 180 as a special symbol 189 in the bonus game; rearranging the scatter symbols 180, based on a predetermined timing; when the scatter symbols 180 rearranged include the special symbol 189, changing the scatter symbols 180 (picture symbols of “SUN” 181, “HEART” 182 and “MOON” 183), which can be changed into a special symbol, into the special symbols 189; and awarding a prize relative to the number of the special symbols 189.

According to the above playing method, in case that a bonus game is awarded, when the scatter symbols rearranged include the special symbol, the scatter symbol that can be changed into a special symbol is changed into the special symbol and a prize relative to the number of the special symbols after the change can be awarded. Thereby, a player can know an obtainable prize by seeing the number of the scatter symbols that can be changed into the special symbols rearranged on a display, so that a game characteristic, which is simple and easy for the player, can be provided.

(Display State)

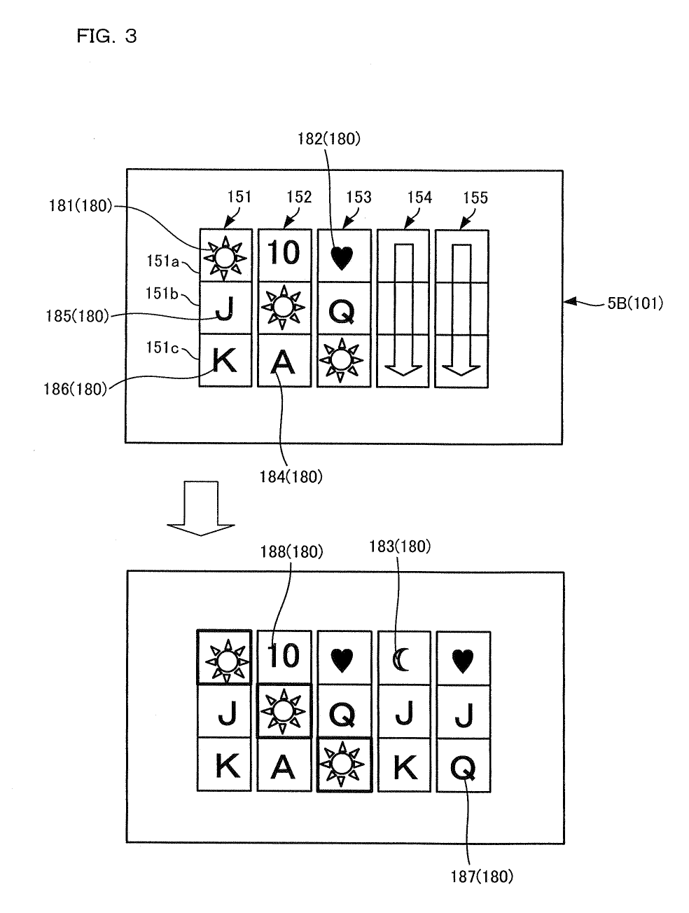

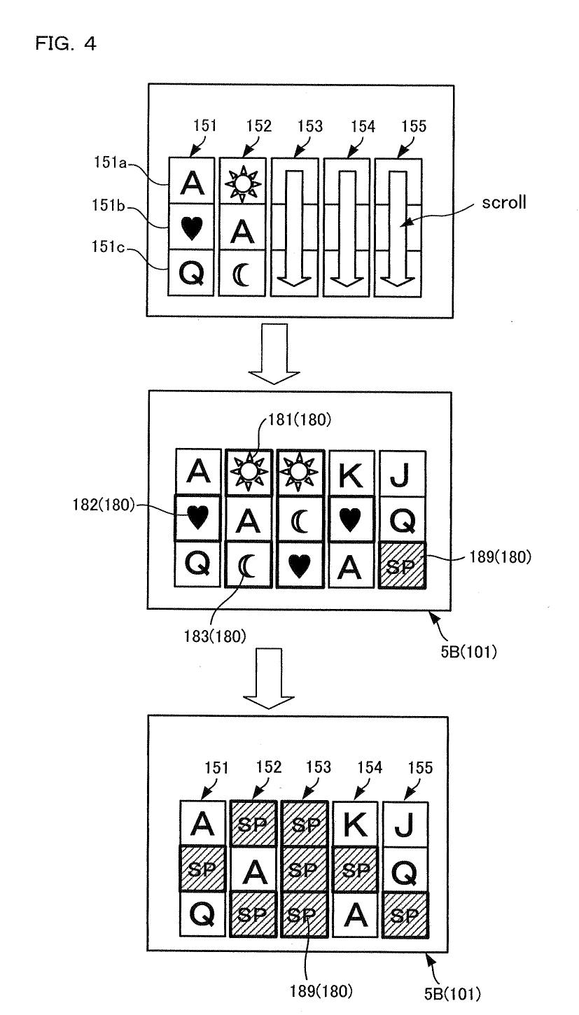

It is specifically described an example of a display state of the display 101, with respect to the operation processes of the gaming machine 1 and the playing method. In the mean time, as shown in FIGS. 3 and 4, the display state is described with reference to a structure in which the display 101 arranges the symbols 180 in a video reel manner.

The display 101 has display windows 151 to 155 that arrange the symbols 180. The display windows 151 to 155 are arranged in a center of the display 101. A symbol column consisting of the symbols 180 is scrolled in the display windows 151 to 155 (see FIG. 3). In addition, the respective display windows 151 to 155 are divided into upper stages 151a, 152a, 153a, 154a, 155a, central stages 151b, 152b, 153b, 154b, 155b and lower stages 151c, 152c, 153c, 154c, 155c. The symbols 180 are respectively stopped (arranged) in the respective stages 151a to 155a, 151b to 155b, 151c to 155c. For example, in FIG. 3, “SUN” is stopped in the upper stage 151a of the display window 151, “SUN” is stopped in the central stage 152b of the display window 152 and “SUN” is stopped in the lower stage 153c of the display window 153. Thereby, the display windows 151 to 155 display a symbol matrix consisting of five columns/three rows, as an arrangement area. In the mean time, the symbol matrix is not limited to five columns/three rows.

Furthermore, in a basic game (base game), when a predetermined number of the symbols 181 to 188 referred to as scatter symbols is displayed on the display 101 as a winning combination, a process of awarding a prize such as coin is executed. For example, as shown in FIG. 3, when three or more “SUN” 181, which is one of the scatter symbols, are rearranged (displayed) on the display 101, a coin is paid out.

In the mean time, in this embodiment, the symbols 181 to 188 are set as the scatter symbols. However, the invention is not limited thereto. For example, a specific symbol only may be set as a scatter symbol. In addition, a scatter symbol may be chosen by a player. In addition, a payline L that horizontally traverses the central stages 151b to 155b of the respective display windows 151 to 155 may be provided. When the symbols stopped on the payline L constitute a predetermined combination, a process of paying out a coin may be performed. In other words, the payline L is provided to determine a combination of the symbols 180. When the symbols 180 are rearranged on and out of the payline L, a combination is determined for only the symbols 180 rearranged on the payline. As a result of the determination for a combination, when it is made a winning combination, it is carried out, for example, a process of paying out a coin based on the winning combination.

FIG. 4 shows a state of the symbols 180 rearranged as a bonus game when the symbols 180 are rearranged in a basic game (base game) of FIG. 3 and a relation of the symbols 180 includes a predetermined relation (in this embodiment, three “SUN” 181 are rearranged in the display windows 151 to 155). For example, as shown in FIG. 4, when a symbol “SP”, which is the special symbol 189, is rearranged in the display window 155c, all the picture symbols (“SUN” 181, “HEART” 182 and “MOON” 183) stopped in the display windows 151 to 155 are replaced and displayed with the symbol “SP”, which is the special symbol 189.

(Symbol, Combination and the Like)

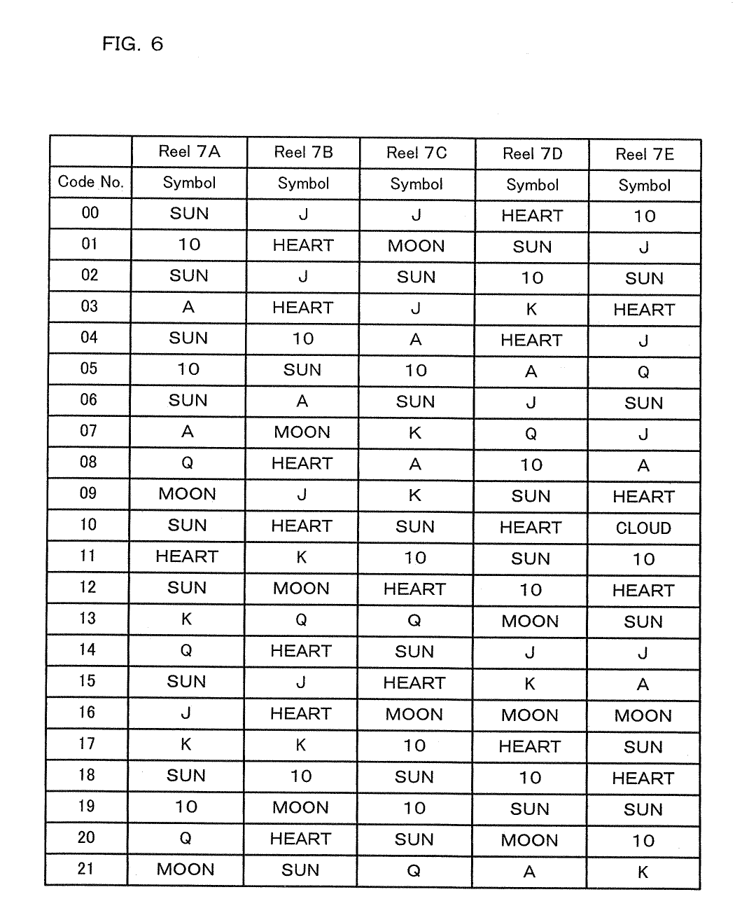

As shown in FIG. 6, the symbols 180 to be displayed in the display windows 151 to 155 of the display 101 constitute the symbol columns by twenty-two symbols. The symbols constituting the respective symbol columns are given with one code number of zero to twenty-one. Each of the symbol columns is constituted with a combination of symbols of the picture symbols “SUN” 181, “HEART” 182 and “MOON” 183, “A” 184, “J” 185, “K” 186, “Q” 187 and “10” 188.

The three successive symbols in the symbol columns are displayed (arranged) in the upper stages 151a, 152a, 153a, 154a, 155a, the center stages 151b, 152b, 153b, 154b, 155b and the lower stages 151c, 152c, 153c, 154c, 155c, respectively, so that they constitute a symbol matrix of five columns/three rows in the display windows 151 to 155. When a BET button is pushed and then a start button is pushed to start a game, the symbol columns constituting the symbol matrix are scrolled. When a predetermined time period has elapsed after the scroll, each scroll of the symbols is stopped (rearranged).

In addition, the symbols 181 to 188 are set as the scatter symbols. The scatter symbol is a symbol that makes an advantageous state to a player when a predetermined number of the scatter symbols are displayed in the display windows 151 to 155. The advantageous state is a state in which a coin is paid out in accordance with the scatter symbols, a state in which the payout-number of coins is added to a credit, a state in which a bonus game is started, and the like.

For example, when three or more symbols of “SUN” 181 are rearranged in the display windows 151 to 155, a bonus game is triggered and a gaming state is shifted to a bonus game from a base game (basic game). In addition, when three or more symbols of “SUN” 181 are stopped in the display windows 151 to 155, 20 coins (game medium) are paid out per one bet.

In the mean time, the bonus game is a gaming state that is more advantageous than a base game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the base game. For example, the bonus game may include a state in which it is possible to obtain more game media than the base game, a state in which it is possible to obtain a game medium in a higher probability than in the base game, a state in which a game medium is less consumed than in the base game, and the like. Specifically, a free game, a second game, a feature game and the like are examples of the bonus game.

(Mechanical Structure of the Slot Machine 1)

In the followings, it will be described an example of the slot machine 1 structured in a mechanical and electrical manner.

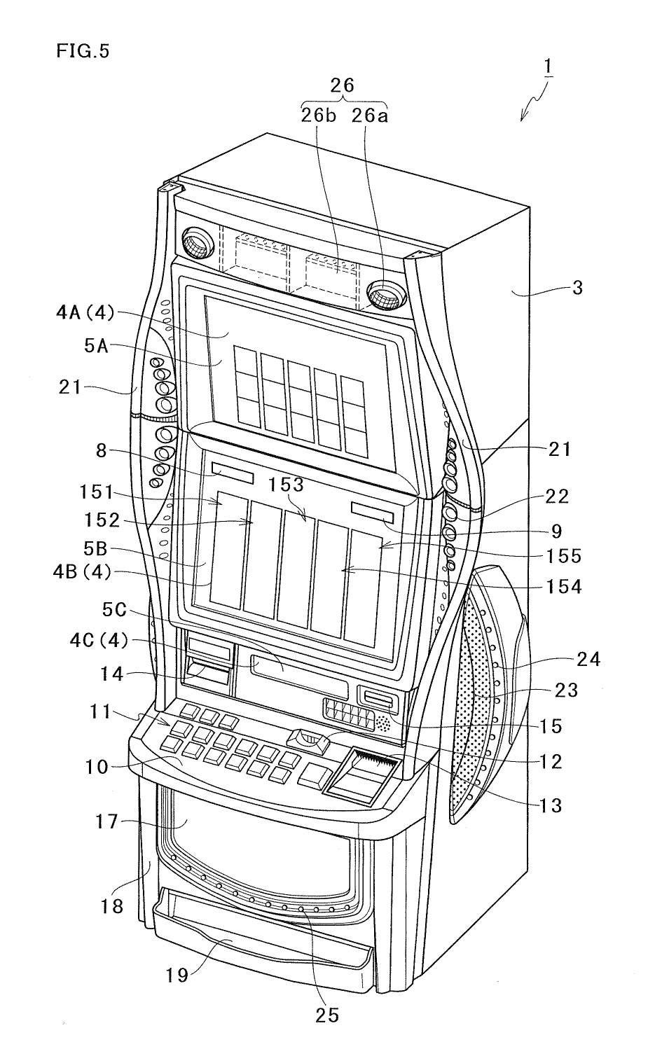

As shown in FIG. 5, the slot machine 1 is an upright-type slot machine provided in a game arcade such as casino and the like and has a cabinet 3 for receiving electrical or mechanical parts so as to execute a game aspect. As a display unit 4 for displaying the game information based on a game operation of a player, there are provided an upper variable display unit 4A, a central variable display unit 4B and a lower variable display unit 4C, for example. Each of the display units 4A, 4B, 4C is attached to a front of the cabinet 3 that is longitudinally long.

The upper variable display unit 4A is a display unit on which a player fixes the eyes during the unit game and has a transparent upper liquid crystal panel 5A that is fixed to a front door of the cabinet 3. A variety of effect images are displayed in the upper liquid crystal panel 5A during the unit game. For example, an effect of a moving picture is performed in the upper liquid crystal panel 5A when a winning is made, for example.

The central variable display unit 4B is a rotating symbol display panel on which a player always fixes the eyes and has a transparent central liquid crystal panel 5B that is fixed to the front door of the cabinet 3. To the central liquid crystal panel 5B are provided five display windows 151 to 155. Moreover, a payout-number display unit 8 and a credit-number display unit 9 are displayed in an upper part of the central liquid crystal panel 5B.

The lower variable display unit 4C has a lower liquid crystal panel 5C that displays a point-number recorded in a card or a point-number of a game. A numerical value displayed in the lower liquid crystal panel 5C is based on a display result of the central variable display unit 4B. When a winning combination is made in the central variable display unit 4B, a point-number of a game displayed in the lower liquid crystal panel 5C is added on the basis of the winning combination made. A ticket printer 14 is provided to a left side of the lower liquid crystal panel 5C and a card reader 15 is provided to a right side of the lower liquid crystal panel 5C.

An operating table 10 that protrudes forward from the front face of the cabinet 3 is disposed below the lower variable display unit 4C. On the operating table 10, there are arranged operating buttons 11 (for example, bet button, collect button, start button 11a and the like) as an operating unit enabling a player to operate a game. In addition, a coin insertion slot 12 and a bill insertion slot 13 are provided to the operating table 10.

A waist-position panel 17 is disposed below the operating table 10. The waist-position panel 17 is a plastic panel having a game-related image printed thereto. The waist-position panel 17 is fixed to a lower front door 18 and illuminated by a cold cathode-ray tube. In addition, a coin receiving portion 19 that collects coins, which are paid out on the basis of a game result, is disposed below the waist-position panel 17.

Furthermore, a light-emitting unit 20 is disposed to the cabinet 3 of the slot machine 1 so that it surrounds a game area including the upper variable display unit 4A, the central variable display unit 4B, the lower variable display unit 4C and the operating table 10. The light-emitting unit 20 includes side lamps 22 that are provided to inclined parts 21, which are protruded in a bow shape at front right and left ends of the cabinet 3 and at side parts over the upper variable display unit 4A, the central variable display unit 4B and the lower variable display unit 4C, speaker lamps 24 that are provided to arc-shaped speaker 23, which are sideways protruded at the right and left ends of the cabinet 3 adjacent to the operating table 10, and are arranged along edges of the speakers 23, under lamps 25 that are provided to a lower front door 18 and arranged along lower edges of the waist-position panel 17, and top lamps 26 that are provided to an upper part of the upper variable display unit 4A and have power lamps 26a disposed at both sides and central band-shaped lamps 26b arranged in a horizontal direction.

(Electrical Structure of the Slot Machine 1)

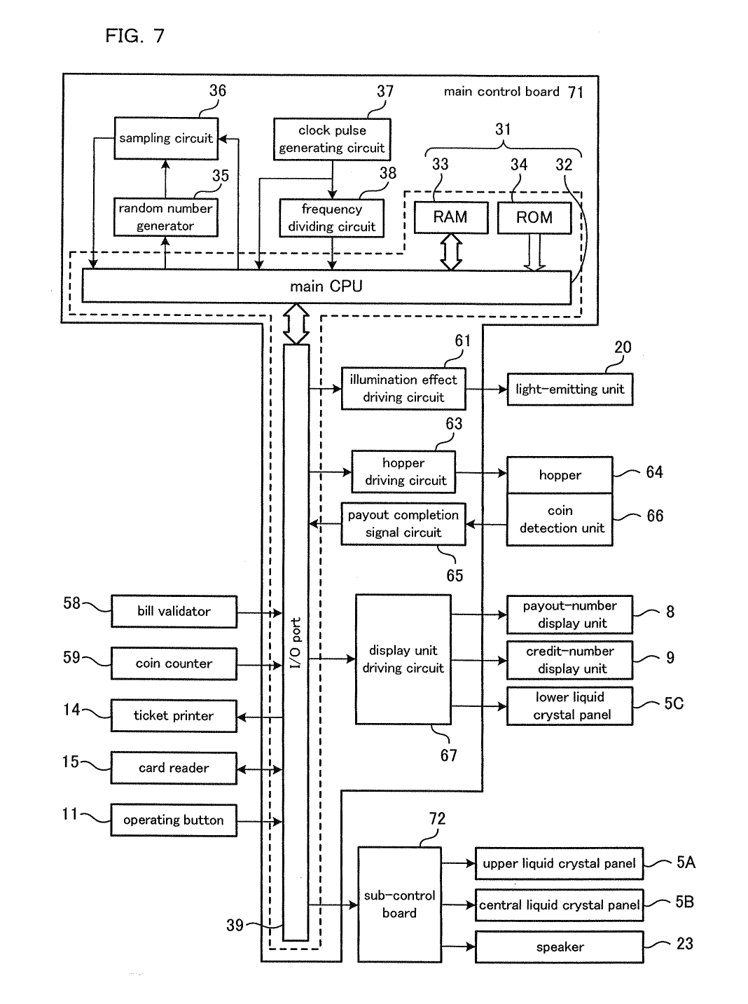

FIG. 7 is a block diagram showing an entire electrical structure of the slot machine 1. As shown in FIG. 7, the slot machine 1 has many components about a main control board 71 including a microcomputer 31. The main control board 71 has a microcomputer 31, a random number generator 35, a sampling circuit 36, a clock pulse generating circuit 37, a frequency dividing circuit 38, an illumination effect driving circuit 61, a hopper driving circuit 63, a payout completion signal circuit 65 and a display unit driving circuit 67.

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the slot machine 1. The RAM 33 stores data, a lottery table such as a winning combination lottery table 90 for a base game and a winning combination lottery table 91 for a bonus game, and a program such as a stop symbol determining program, a special symbol determining program and a bonus game stop symbol determining program data or a stop symbol determining program used when the main CPU 32 operates. For example, a random number value that is sampled by a sampling circuit 36 is temporarily maintained in the RAM after a game starts. In addition, the code numbers of the reels R1, R2, R3 are stored in the RAM. The ROM 34 stores a program such as game executing process or bonus game process program that is executed by the main CPU 32 and permanent data.

The random number generator 35 is operated in accordance with an instruction of the main CPU 32 and generates a random number within a predetermined range. The sampling circuit 36 samples any random number of the random numbers that are generated by the random number generator 35 in accordance with an instruction of the main CPU 32 and inputs the sampled random number into the main CPU 32. The sampled random number is used in a game executing process, bonus game process and the like, which will be described later. The clock pulse generating circuit 37 generates a reference clock for operating the main CPU 32 and the frequency dividing circuit 38 inputs a signal that the reference clock is divided in a predetermined period to the main CPU 32.

Moreover, the main control board 71 is associated with the operating buttons 11 including a start button for inputting an instruction to start the scroll of the symbol columns, a collect button, a bet button and the like and allows signals corresponding to the push of the buttons to be inputted into the main CPU 32 via the I/O port 39.

In addition, the main control board 71 is associated with a bill validator 58, a coin counter 59, a ticket printer 14 and a card reader 15.

The bill validator 58 reads an image of bill inserted into the bill insertion slot 13 and receives the genuine bill in the cabinet 3. In addition, when receiving the genuine bill, the bill validator 58 outputs an input signal to the main CPU 32 based on an amount of the bill. The main CPU 32 stores a credit-number in the RAM 33, which corresponds to the amount of bill transmitted by the input signal.

The coin counter 59 is provided in the coin insertion slot 12 and identifies whether the coin inserted into the coin insertion slot 12 by the player is genuine or not. The questionable coin is discharged to the coin receiving portion 19. In addition, the coin counter 59 outputs an input signal to the main CPU 32 when it detects a genuine coin.

The ticket printer 14 prints a barcode on a ticket, in which data such as credit-number stored in the RAM 33, the day and time and identification number of the slot machine 1 is coded, based on the control signal outputted from the main CPU 32, and then outputs a ticket having the barcode attached thereto.

The card reader 15 reads the data from a smart card to transmit it to the main CPU 32, or writes the data to the smart card based on a control signal from the main CPU 32.

The illumination effect driving circuit 61 outputs an effect signal that causes the light-emitting unit 20 to execute an illumination effect. The light-emitting unit 20 consists of many lamps or LED including the side lamps 22, the speaker lamps 24, the under lamps 25 and the top lamps 26.

The hopper driving circuit 63 drives a hopper 64 under control of the main CPU 32. The hopper 64 executes an operation of paying out a coin and pays out the coin to the coin receiving portion 19. The payout completion signal circuit 65 inputs data of the coin-number from a coin detection unit 66 associated thereto and inputs a signal, which notifies payout completion of the coin when the coin-number reaches a predetermined number, to the main CPU 32. The coin detection unit 66 measures the number of coins paid out by the hopper 64 and inputs data of the measured number to the payout completion signal circuit 65. The display unit driving circuit 67 controls display operations of various display units such as the lower liquid crystal panel 5C.

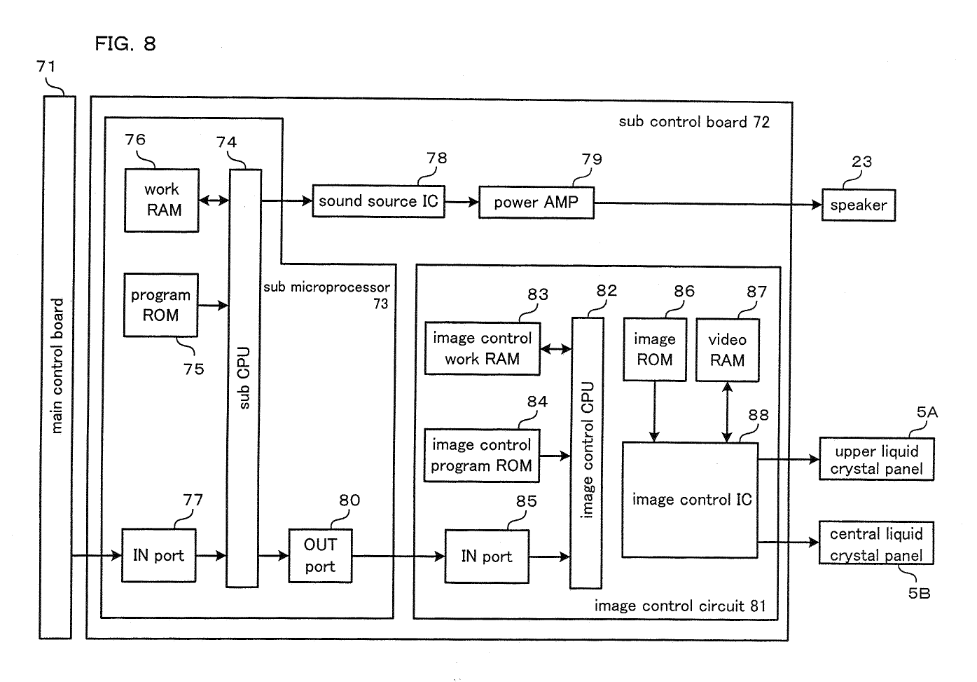

Further, the main control board 71 is associated with a sub control board 72. As shown in FIG. 8, the sub control board 72 performs a display control of the upper liquid crystal panel 5A of the upper variable display unit 4A, a display control of the central liquid crystal panel 5B of the central variable display unit 4B and an output control of a voice sound by the speaker, based on commands inputted from the main control board 71. The sub control board 72 is included on a circuit board different from the circuit board constituting the main control board 71 and has a microcomputer 73 (hereinafter, referred to as “sub microcomputer”) as a main component. In addition, the sub control board has a sound source IC 78 controlling a voice sound outputted from the speaker 23, a power AMP 79 serving as an amplifier and an image control circuit 81 serving as a display control means of the upper liquid crystal panel 5A and the central liquid crystal panel 5B.

The sub microcomputer 73 has a sub CPU 74 that performs a control operation in accordance with a control command transmitted from the main control board 71, a program ROM 75 serving as a memory means, a work RAM 76, an IN port 77 and an OUT port 80. Although the sub control board 72 does not have a clock pulse generating circuit, a frequency dividing circuit, a random number generator and a sampling circuit, it is structured to execute a random number sampling on the operating program of the sub CPU 74. The program ROM 75 stores a control program that is executed in the sub CPU 74. The work RAM 76 is structured to serve as a temporary memory means when the control program is executed in the sub CPU 74.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the upper liquid crystal panel 5A and the central liquid crystal panel 5B, in accordance with the image control program stored in the image control program ROM 84, based on a parameter that is set in the sub microcomputer 73.

The image control program ROM 84 stores an image control program that is related to a display in the upper liquid crystal panel 5A and the central liquid crystal panel 5B, or various selection tables. The image control work RAM 83 is configured to serve as a temporary memory means when the image control program is executed in the image control CPU 82. The image control IC 88 forms an image corresponding to the content determined in the image control CPU 82 and outputs it to the upper liquid crystal panel 5A and the central liquid crystal panel 5B.

The image ROM 86 stores dot data for forming an image. The video RAM 87 serves as a temporary memory means when an image is formed in the image control IC 88.

(Winning Combination Lottery Table for a Base Game)

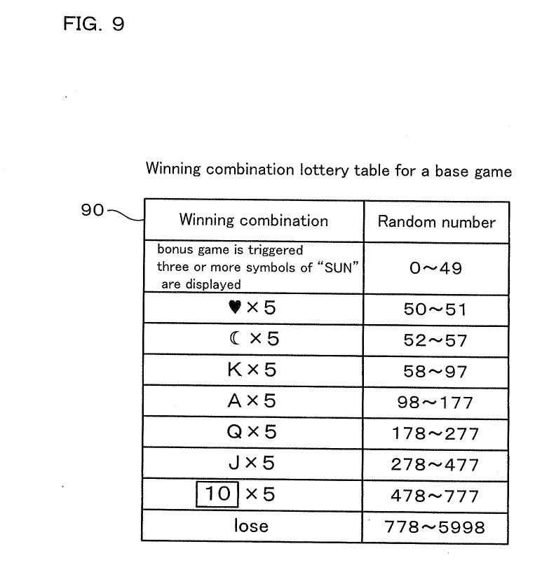

In the followings, a winning combination lottery table 90 for a base game, which is used in a basic game, will be described with reference to FIG. 9.

As shown in FIG. 9, a range of the random numbers, which are used in a winning combination lottery table 90 for a base game, is zero to 5998. When the random number sampled through the sampling circuit 36 is zero to forty-nine, a bonus game is triggered. In this case, three or more symbols of “SUN” 181 are stopped in the display windows 151 to 155 at the same time and a game state is shifted to a bonus game. In addition, when the random number sampled through the sampling circuit 36 is fifty to fifty-one, a winning combination of “HEART” 182 is determined. Then, five symbols of “HEART” 182 are stopped in the display windows 151 to 155. In addition, when the random number sampled through the sampling circuit 36 is fifty-two to fifty-seven, a winning combination of “MOON” 183 is determined. Then, five symbols of “MOON” 183 are stopped in the display windows 151 to 155. Likewise, when the random number is fifty-eight to ninety-seven, a winning combination of “K” 186 is determined. When the random number is 98 to 177, a winning combination of “A” 184 is determined. When the random number is 178 to 277, a winning combination of “Q” 187 is determined. When the random number is 278 to 477, a winning combination of “J” 185 is determined. When the random number is 478 to 777, a winning combination of “10” 188 is determined. In addition, when the random number sampled through the sampling circuit 36 is 778 to 5998, a loss is determined, so that a combination of lose symbols is stopped in the display windows 151 to 155.

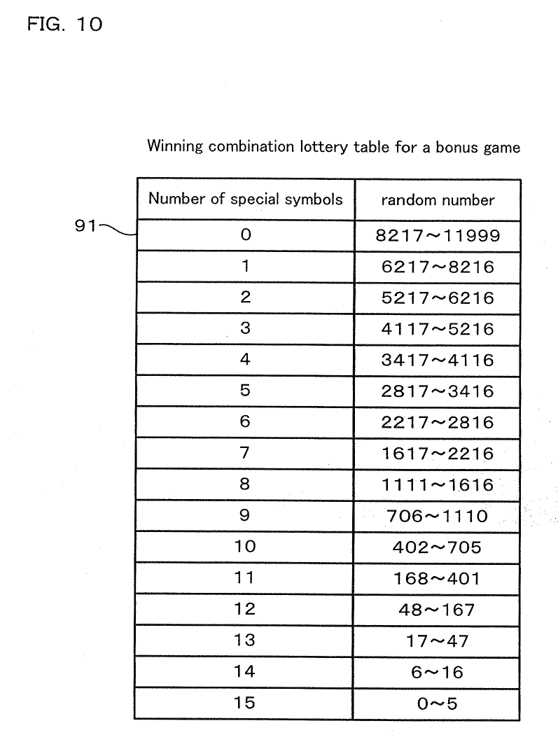

In the followings, a winning combination lottery table 91 for a bonus game, which is applied when a bonus game trigger is determined in the winning combination lottery table 90 for a base game, will be described with reference to FIG. 10. FIG. 10 shows a winning combination lottery table for a bonus game.

As shown in FIG. 10, a range of the random numbers, which are used in a winning combination lottery table 90 for a bonus game, is zero to 11999. When the random number sampled through the sampling circuit 36 is zero to five, the special symbols 189 and the picture symbols (symbols 181 to 183) are stopped in the display windows 151 to 155 so that the sum total thereof is fifteen. In addition, when the random number sampled through the sampling circuit 36 is six to sixteen, the special symbols and the picture symbols are stopped in the display windows 151 to 155 so that the sum total thereof is fourteen.

Likewise, when the random number is seventeen to forty-seven, the special symbols and the picture symbols are stopped in the display windows 151 to 155 so that the sum total thereof is thirteen. When the random number is 48 to 167, the special symbols and the picture symbols are stopped in the display windows 151 to 155 so that the sum total thereof is twelve. When the random number is 168 to 401, the special symbols and the picture symbols are stopped in the display windows 151 to 155 so that the sum total thereof is eleven. When the random number is 402 to 705, the special symbols and the picture symbols are stopped in the display windows 151 to 155 so that the sum total thereof is ten. When the random number is 706 to 1110, the special symbols and the picture symbols are stopped in the display windows 151 to 155 so that the sum total thereof is nine. When the random number is 1111 to 1616, the special symbols and the picture symbols are stopped in the display windows 151 to 155 so that the sum total thereof is eight. When the random number is 1617 to 2216, the special symbols and the picture symbols are stopped in the display windows 151 to 155 so that the sum total thereof is seven. When the random number is 2217 to 2816, the special symbols and the picture symbols are stopped in the display windows 151 to 155 so that the sum total thereof is six. When the random number is 2817 to 3416, the special symbols and the picture symbols are stopped in the display windows 151 to 155 so that the sum total thereof is five. When the random number is 3417 to 4116, the special symbols and the picture symbols are stopped in the display windows 151 to 155 so that the sum total thereof is four. When the random number is 4117 to 5216, the special symbols and the picture symbols are stopped in the display windows 151 to 155 so that the sum total thereof is three. When the random number is 5217 to 6216, the special symbols and the picture symbols are stopped in the display windows 151 to 155 so that the sum total thereof is two. When the random number is 6217 to 8216, the special symbols and the picture symbols are stopped in the display windows 151 to 155 so that the sum total thereof is one. When the random number is 8217 to 11999, a loss is made and the special symbols and the picture symbols are stopped in the display windows 151 to 155 so that the sum total thereof is zero.

(Payout Table for a Bonus Game)

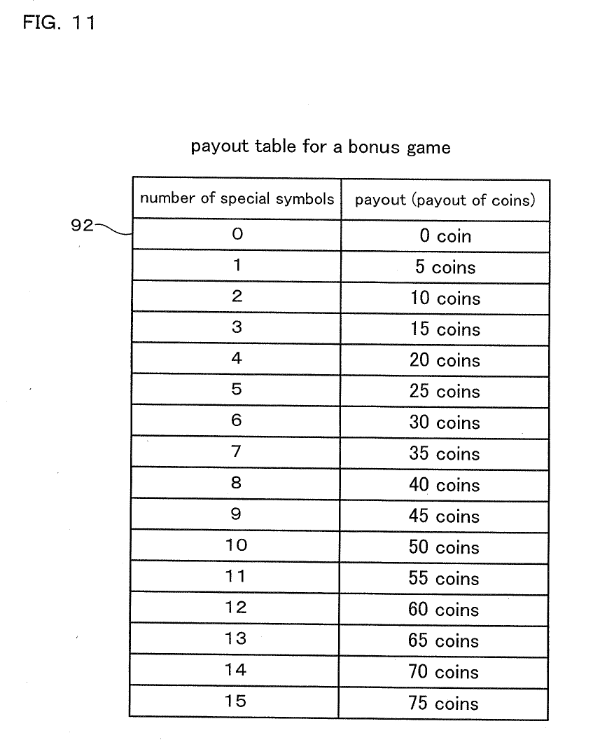

In the followings, a payout table 92 for a bonus game, which shows a payout-number of coins relative to the sum of the special symbols 189, will be described with reference to FIG. 11. FIG. 11 shows a payout table for a bonus game.

As a result of the sampling with the winning combination lottery table 92 for a bonus game, the coins are paid out in accordance with the sum of the special symbols 189 and the picture symbols 181 to 183 (the pictures symbols are changed into the special symbols in a bonus game process that will be described later) displayed in the display windows 151 to 155, based on the payout table 92 for a bonus game.

To be more specific, when the sum of the special symbols 189 is zero, no coins is paid out. When the sum of the special symbols 189 is one, five coins are paid out. When the sum of the special symbols 189 is two, ten coins are paid out. When the sum of the special symbols 189 is three, fifteen coins are paid out. When the sum of the special symbols 189 is four, twenty coins are paid out. When the sum of the special symbols 189 is five, twenty-five coins are paid out. When the sum of the special symbols 189 is six, thirty coins are paid out. When the sum of the special symbols 189 is seven, thirty-five coins are paid out. When the sum of the special symbols 189 is eight, forty coins are paid out. When the sum of the special symbols 189 is nine, forty-five coins are paid out. When the sum of the special symbols 189 is ten, fifty coins are paid out. When the sum of the special symbols 189 is eleven, fifty-five coins are paid out. When the sum of the special symbols 189 is twelve, sixty coins are paid out. When the sum of the special symbols 189 is thirteen, sixty-five coins are paid out. When the sum of the special symbols 189 is fourteen, seventy coins are paid out. When the sum of the special symbols 189 is fifteen, seventy-five coins are paid out.

(Operation of the Slot Machine 1: Main Control Board 71)

In the followings, a process that is performed in the slot machine 1 will be described. As the main CPU 32 reads out and executes a game program that is stored in the ROM 34, a game is progressed.

(Game Executing Process)

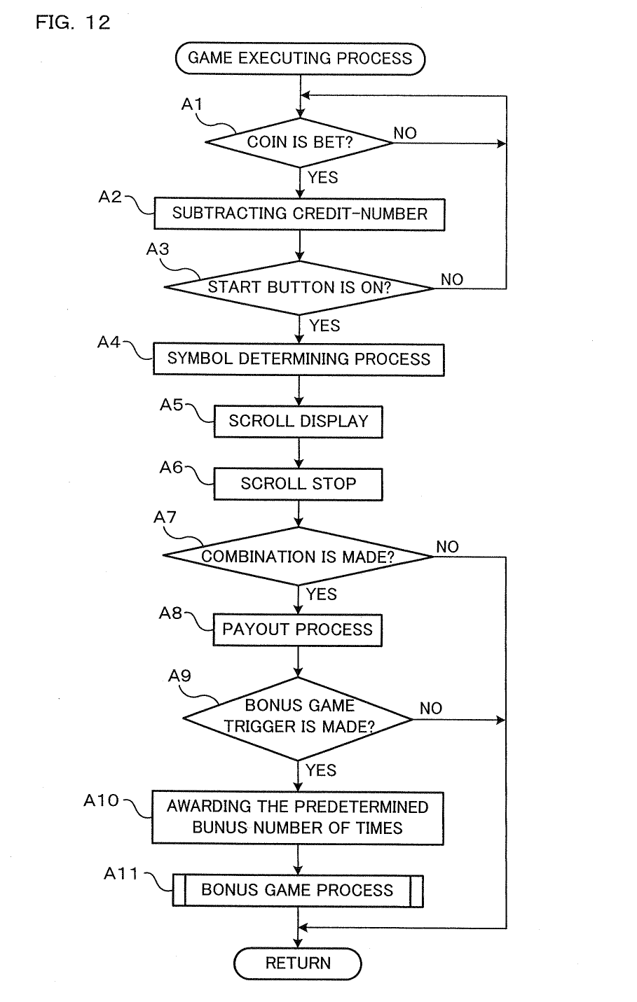

The main CPU 32 of the slot machine 1 carries out a game executing process routine shown in FIG. 12. When the game executing process routine is carried out, the main CPU 32 determines whether a coin is bet or not (A1). In this process, it is determined whether an input signal due to a push of the bet button is received or not. When it is determined that a coin is not bet (A1, NO), the step of A1 is re-executed, so that the CPU waits until a coin is bet.

In the mean time, when it is determined that a coin is bet (A1, YES), the credit-number stored in the RAM 33 is subtracted in accordance with the coin-number (A2). Meanwhile, when the number of coins bet is greater than the credit-number stored in the RAM 33, the step of A2 is re-executed without subtracting the credit-number. In addition, when the number of coins bet exceeds the upper limit (in this embodiment, fifty pieces) allowing a player to bet a coin in a single game, a step of A3 is executed without subtracting the credit-number.

Next, it is determined whether a start button is ON or not (A3). When it is determined that the start button is not ON (A3, NO), the process is returned to the step of A1. Meanwhile, when it is determined that the start button is not ON (for example, the start button is not ON and an instruction to end the game is inputted), it is canceled the subtraction result in the step of A2.

In the mean time, when it is determined that the start button is ON (A3, YES), a symbol determining process is executed (A4). In other words, a stop symbol determining program is executed, based on the winning combination lottery table 90 for a base game stored in the RAM 33, so that a symbol matrix including the fifteen symbols 180 is determined.

Then, the symbols 180 of the display windows 151 to 155 are scrolled (A5). After the scroll of the symbols 180 is started and then a predetermined time (base time) has elapsed, the symbol matrix determined in the step of A4 is stopped (rearranged) in the display windows 151 to 155 (A6).

Then, it is determined whether a combination is made or not, i.e., whether a combination of the symbols 180 stopped in the display windows 151 to 155 is a winning combination or not (A7). When it is determined that the combination is not a winning combination (A7, NO), this routine is ended. In the mean time, when it is determined that the combination is a winning combination (A7, YES), a payout process is executed (A8) In other words, a payout-number of coins based on the winning combination made is calculated. When the coins to be paid out are stored, a predetermined number of credits are added to the credit-number stored in the RAM 33. In the mean time, when the coins are paid out, a control signal is transmitted to the hopper 64, so that a predetermined number of coins are paid out through the coin receiving portion 19.

Then, it is determined whether a bonus game trigger is made as a winning combination (A9). In other words, it is determined whether three or more symbols of “SUN” 181 are arranged in the display windows 151 to 155. When it is determined that a bonus game trigger is not made (A9, NO), this routine is ended. In the mean time, when it is determined that a bonus game trigger is made (A9, YES), a game state is shifted to a bonus game from a base game (basic game). In other words, a bonus game is awarded in which a game can be performed over the predetermined number of times (in this embodiment, 10 times) without betting a coin (A10). Then, a bonus game process is executed (A10). The bonus game process will be described later. Then, this routine is ended.

(Bonus Game Process)

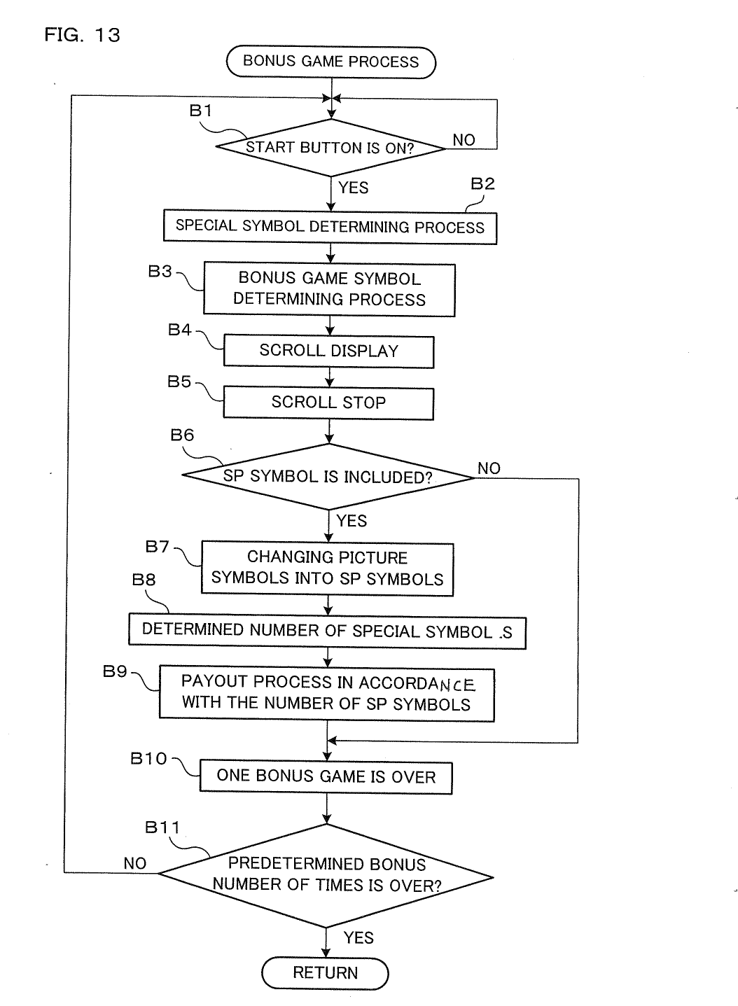

When it is determined in the step of A9 of FIG. 12 that a bonus game trigger is made, the main CPU 32 of the gaming machine 1 executes a bonus game process routine shown in FIG. 13 in a step of A11. The bonus game process routine is stored in the ROM 34.

When the bonus game process routine is executed, it is determined whether a start button is ON (B1). When it is determined that a start button is not ON (B1, NO), the process is returned to the step of B1.

In the mean time, when it is determined that a start button is ON (B1, YES), a special symbol determining process is executed (B2). In other words, a special symbol determining program stored in the RAM 33 is executed, so that the main CPU 32 samples one to five symbols among the symbols (22×5=111) that are displayed in five symbol columns by the twenty-two symbols 180 shown in FIG. 6. Then, the sampled symbols are determined as the special symbols 189 (i.e., changed into the symbols of “SP”).

Then, a bonus game symbol determining process is executed (B3). In other words, a bonus game stop symbol determining program is executed based on the winning combination lottery table 91 for a bonus game stored in the RAM 33, so that a symbol matrix including the fifteen symbols 180 is determined.

Then, the symbols 180 of the display windows 151 to 155 are scrolled (B4). After the scroll of the symbols 180 is started and a predetermined time (base time) has elapsed, the symbol matrix determined in the step of B3 is stopped (rearranged) in the display windows 151 to 155 (B5).

Then, it is determined whether the symbol matrix stopped includes a special symbol 189, i.e., whether the symbols 180 stopped in the display windows 151 to 155 include the special symbol 189 determined in the step of B2 (B6). When it is determined that there is no special symbol 189 (B6, NO), the process proceeds to a step of B10. In the mean time, when it is determined that there is a special symbol 189 (B6, YES), the picture symbols in the symbols 180 stopped in the display windows 151 to 155 are changed into the special symbols 189, which are then displayed (B7). To be more specific, the picture symbols of “SUN” 181, “HEART” 182 and “MOON” 183 stopped in the display windows 151 to 155 are changed into the picture symbols of “SP” (special symbols 189).

Then, it is determined the number of the special symbols 189 stopped in the display windows 151 to 155 (B8). Continuously, a payout process is executed, based on the number of the special symbols 189 determined in the step of B8 and the payout table 92 for a bonus game (B9). In other words, as shown in FIG. 11, a payout-number of coins is calculated, based on the number of the special symbols 189. When the coins to be paid out are stored, a predetermined number of credits are added to the credit-number stored in the RAM 33. In the mean time, when the coins are paid out, a control signal is transmitted to the hopper 64, so that a predetermined number of coins are paid out through the coin receiving portion 19. Thereby, one bonus game is over (B10). In other words, one bonus game of the predetermined bonus number of times (in this embodiment, ten times) awarded by the step of A10 of the game executing process shown in FIG. 12 is ended.

Then, it is determined whether the predetermined bonus number of times (in this embodiment, ten times) awarded by the step of A10 of the game executing process shown in FIG. 12 is ended (B11). To be more specific, it is determined whether 10 times of bonus game are executed. Then, when it is determined that the predetermined bonus number of times is not over (B11, NO), the process is returned to the step of B1. In the mean time, when it is determined that the predetermined bonus number of times is over (B11, YES), this routine is ended.

Like this, in case that a bonus game is awarded, when the symbols 180 rearranged in the display windows 151 to 155 include the special symbols 189, the picture symbols of “SUN” 181, “HEART” 182 and “MOON” 183 are changed into the special symbols 189 and the coins relative to the number of the special symbols 189 after the change can be awarded. Thereby, a player can know an obtainable prize by seeing the number of the special symbols 189 displayed in the display windows 151 to 155, a game characteristic, which is simple and easy for the player, can be provided.

(Process Operation of the Slot Machine 1: Sub Control Board 72)

When the various processes are performed by the game executing process routine in the main control board 71, a result or content corresponding to the process is inputted as a command or data to the sub control board 72. The sub control board 72 performs the display of the payout-number display unit 8 of the central liquid crystal panel 5B or credit-number display unit 9 and the like and displays an effect image in the upper liquid crystal panel 5A. In addition, the sub control board 72 performs an effect relative to an output of the sound from the speaker 23, in combination with, or independently of the effect in the upper liquid crystal panel 5A.

Although the above descriptions have been provided with regard to the characteristic parts so as to understand the invention more easily, the invention is not limited to the embodiment as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be easily derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A gaming machine that is operable under control of a controller, the gaming machine comprising:
an arrangement area of a matrix shape; and
a display that is controlled by the controller to arrange a plurality of scatter symbols in the arrangement area,
wherein the controller operates:
(a1) to set a predetermined scatter symbol of the scatter symbols as a special symbol;
(a2) to rearrange the scatter symbols based on a predetermined timing;
(a3) when the scatter symbols rearranged include the special symbol, to change the predetermined scatter symbol into the special symbol; and
(a4) to award a prize relative to the number of the special symbols.

2. A gaming machine that is operable under control of a controller, the gaming machine comprising:
an arrangement area of a matrix shape; and
a display that is controlled by the controller to arrange a plurality of scatter symbols in the arrangement area,
wherein the scatter symbols include a scatter symbol that is capable of being changed into a special symbol and a scatter symbol that is not capable of being changed into a special symbol, and
wherein the controller operates:
(b1) to set a predetermined scatter symbol of the scatter symbols as a special symbol;
(b2) to rearrange the scatter symbols based on a predetermined timing;
(b3) when the scatter symbols rearranged include the special symbol, to change the scatter symbol, which is capable of being changed into a special symbol, into the special symbol; and
(b4) to award a prize relative to the number of the special symbols rearranged.

3. A gaming machine that is operable under control of a controller, the gaming machine comprising:
an arrangement area of a matrix shape;
a display that is controlled by the controller to arrange a plurality of scatter symbols in the arrangement area; and
a bonus game that is operable when the scatter symbols rearranged include a predetermined relation,
wherein the controller operates:
(c1) to rearrange the scatter symbols, based on a predetermined timing;
(c2) to award a bonus game when a relation of the scatter symbols rearranged includes a predetermined relation;
(c3) to set a predetermined scatter symbol of the scatter symbols as a special symbol in the bonus game;
(c4) to rearrange the scatter symbols based on a predetermined timing;
(c5) when the scatter symbols rearranged include the special symbol, to change the predetermined scatter symbol into the special symbol; and
(c6) to award a prize relative to the number of the special symbols.

4. A gaming machine that is operable under control of a controller, the gaming machine comprising:
an arrangement area of a matrix shape;
a display that is controlled by the controller to arrange a plurality of scatter symbols in the arrangement area; and
a bonus game that is operable when the scatter symbols arranged include a predetermined relation,
wherein the scatter symbols include a scatter symbol that is capable of being changed into a special symbol and a scatter symbol that is not capable of being changed into a special symbol, and
wherein the controller operates:
(d1) to rearrange the scatter symbols, based on a predetermined timing;
(d2) to award a bonus game when a relation of the scatter symbols rearranged includes a predetermined relation;
(d3) to set a predetermined scatter symbol of the scatter symbols as a special symbol in the bonus game;
(d4) to rearrange the scatter symbols based on a predetermined timing;
(d5) when the scatter symbols rearranged include the special symbol, to change the predetermined scatter symbol into the special symbol; and
(d6) to award a prize relative to the number of the special symbols.

5. A playing method of a gaming machine using an arrangement area of a matrix shape and a display that is controlled to arrange a plurality of scatter symbols in the arrangement area, the method comprising the steps of:
setting a predetermined scatter symbol of the scatter symbols as a special symbol;
rearranging the scatter symbols, based on a predetermined timing;
when the scatter symbols rearranged include the special symbol, changing the predetermined scatter symbol into the special symbol; and
awarding a prize relative to the number of the special symbols.
